(19) United States
(12) Patent Application Publication
(10) Pub. No.: US 2025/0319910 A1
(43) Pub. Date: Oct. 16, 2025

(54) METHOD FOR DETERMINING AT LEAST ONE GEOMETRY PARAMETER OF A RAILROAD TRACK AND SYSTEM FOR IMPLEMENTING THE METHOD

(71) Applicant: MATISA Matériel Industriel S.A., Crissier (CH)

(72) Inventors: Marc-Antoine SAVOYAT, Semsales (CH); Guillaume RICHOZ, Semsales (CH)

(73) Assignee: MATISA Matériel Industriel S.A., Crissier (CH)

(21) Appl. No.: 18/868,025

(22) PCT Filed: May 25, 2023
(86) PCT No.: PCT/EP2023/064105

§ 371 Date: Nov. 21, 2024

(30) Foreign Application Priority Data
May 28, 2022 (FR) FR2205102

(51) Int. Cl. B61D 15/12; B61K 9/08; G01C 21/16

(52) U.S. Cl. CPC B61D 15/12; B61K 9/08; G01C 21/1656

(57) ABSTRACT

The method of determining at least one geometry parameter of a railroad track (1) comprises the steps of: providing for a vehicle (10) carrying an inertial unit (34), a piece of equipment (28) for measuring at least one relative orientation component of at least rows of rails relative to the inertial unit and one or more odometers (26) to travel along the railroad track (1), calculating successive values of at least one absolute positioning or orientation component of the observed row of rails (2) according to the signals produced by the odometers (26), the piece of measuring equipment (28) and the inertial unit (34), constructing a function s→G(s) linking successive curved-abscissa values to concomitant values from the successive values of the absolute positioning or orientation component of the observed row of rails in the area of space, applying a bandpass or high-pass linear filter to the function s→G(s) so as to construct a filtered function s→F(s), and subsequently computing the integral value [Math 14].

### TECHNICAL FIELD OF THE INVENTION

The invention relates to the determination of certain parameters of the geometry of a railroad track, in particular with a view to its inspection or control, for example during laying, monitoring, maintenance or refurbishment.

### PRIOR ART

The main geometry parameters of a track defined in the EN 13848 standard are:
gauge: smallest distance between rails up to 14 mm below the running surface;
longitudinal level: variation of successive running surface heights in relation to a reference altitude which is a sliding average;
cant: difference in elevation between the running surfaces of the left and right rails;
alignment: variation of positions in the horizontal plane of the position of each row of rails in relation to a reference position which is a sliding average;
twist: variation in cant.

Measurements of longitudinal level, alignment, and twist are measurements of variation. They are relative measurements, as opposed to absolute measurements such as cant and gauge. According to the standard, longitudinal level and alignment are studied in different wavelength ranges:
D1: 3 m to 25 m
D2: 25 m to 70 m
D3: 70 m to 150 m

To determine the geometry of a railroad track, an instrumented vehicle is known to travel on the track, its body or bogie chassis being fitted with an inertial unit providing gyroscopic measurements of yaw, pitch and roll angles and accelerometric measurements along three axes. The vehicle is also equipped with detection lasers to determine the relative position of the chassis, and therefore of the inertial unit, in relation to the rows of the railroad track.

Such a non-contact inertial measurement device is used in particular in the IRIS 320 (TGV d′Inspection Rapide des Installations de Sécurité à 320 km/h) high-speed measurement train, which measures all track geometry parameters at speeds up to 360 km/h.

One drawback of this system is that it imposes a minimum speed for the measurement vehicle on the track. At low speeds, the accelerometric signals which, by double temporal integration, provide access to displacements in all three dimensions of space, are weak and do not utilize the full dynamic range of the sensors. As a result, accelerometric measurements are potentially subject to systematic inaccuracies or biases, which are amplified by double integration operations, to the point of generating a constant temporal drift when estimating displacements in all three dimensions. In practice, it is noted that these drifts are no longer negligible below a certain traffic speed, which in practice can be 60 km/h, so that it is not possible to obtain measurements for slow runs, or for runs with stops. The field of application for measurement vehicles equipped with such a conventional inertial measurement system is therefore limited. In particular, they cannot be used on a track renovation site, which progresses at a working speed well below the minimum operating speed of the measuring device, and which may have a speed of zero during stops of arbitrarily long duration.

### DISCLOSURE OF THE INVENTION

The aim of the invention is to remedy the disadvantages of the prior art and to provide means for determining, with the precision desired in practice, the geometry of a railroad track, which can be implemented at low track speeds including during arbitrarily long stops.

According to a first aspect of the invention, a method is proposed for determining at least one geometry parameter of a railroad track with two rows, wherein:
a vehicle carrying an inertial unit, a piece of equipment for measuring at least one relative orientation component of at least one of the two rows of rails with respect to the inertial unit, and one or more odometers is made to travel over the track,
successive values of at least one absolute orientation component of the inertial unit in a geostationary reference frame are determined as a function of at least signals produced by the inertial unit,
for at least one observed row of rails out of the two rows of rails, and preferably for each of the two rows of rails taken as an observed row of rails,
successive values of the vehicle's curved-abscissa values on the observed row of rails are determined as a function of at least the signals produced by the odometer(s),
successive values of at least one relative orientation component of the observed row of rails with respect to the inertial unit are determined as a function of at least the signals produced by the measuring equipment,
successive values of at least one absolute orientation or absolute positioning component of the observed row of rails are calculated as a function of at least successive values of the absolute orientation component of the inertial unit and successive values of the relative orientation component of the observed row of rails with respect to the inertial unit,
a function s→G(s) is constructed which links at least some of the successive curved-abscissa values to concomitant values among the successive values of the absolute orientation or absolute positioning component of the row of rails observed in space,
a high-pass or bandpass linear filter is applied to the function s→G(s) so as to construct a filtered function s→F(s),
for a succession of current curved-abscissa values/among the curved-abscissa values, an integral I(l) is estimated over a given curved-abscissa interval bounded by a reference curved-abscissa value l₀ and by the current curved-abscissa value l, of the filtered function

$$I ( l ) = {\int }_{s = {l}_{o}}^{s = l} F ( s ) ds \qquad [ Math 1 ]$$

By performing a single spatial integration rather than a double integration of each observed row of rails to a filtered function linking the vehicle's curved-abscissa to an absolute orientation or absolute positioning component, all time-related effects are eliminated, particularly drift effects.

In practice, successive curved-abscissa values are not necessarily determined at constant distance intervals. In particular, the various signals can be sampled at constant time intervals, preferably synchronized so as to obtain a good match between the values determined from the signals from the inertial measurement unit, the odometer(s), and the measurement equipment.

The inertial unit must be accurate enough to provide absolute orientation components in a geostationary reference frame, i.e. without drift. It is therefore a type of control unit whose gyroscopes are able to detect the projection of the earth's rotation and whose accelerometers are able to detect the projection of gravity.

By applying the bandpass or high-pass filter to the input function s→G(s) before the integration operation, the potential digital instabilities that would result from integrating the continuous component of the input function are avoided. The linear filter used is preferably a finite impulse response filter of any order N, preferably greater than or equal to 2.

Preferably, the linear filter is a bandpass filter, preferably in one of the three following bands: 3 m to 25 m, 25 m to 70 m, 70 m to 150 m, or an arrow calculation function. In practice, the same function s→G(s) can naturally be used to construct several filtered functions in parallel, each for a different wavelength band or filter type.

In practice, the estimate of the integral is obtained by a discrete sum, preferably the integral I(l) is estimated by a Riemann sum or by the trapezoidal method over the given interval, with a step size of less than 25 cm, and preferably less than 1 cm.

According to one embodiment, the operation of calculating successive values of at least one absolute orientation or positioning component of the observed row of rails consists, at successive instants, of an algebraic sum of an instantaneous value of the absolute orientation component of the inertial unit and of a simultaneous instantaneous value of the relative orientation component of each of the observed rows of rails with respect to the inertial unit.

In one embodiment, the relative orientation component of the observed row of rails with respect to the inertial unit is an orientation angle in a horizontal plane, and the absolute orientation component of the inertial unit is a yaw angle, the integral I(l) being an alignment parameter. If ψ_{R} is the instantaneous value of the angle determined by the measuring equipment in the horizontal plane between the longitudinal direction of the inertial measurement unit and the direction of the observed row of rails, and ψ_{C} the instantaneous value of the yaw angle determined simultaneously by the inertial unit, the absolute orientation component ψ_{A} of the observed row of rails can be expressed as the algebraic sum:

$${ψ}_{A} = {ψ}_{R} + {ψ}_{C} \qquad [ Math 2 ]$$

In another embodiment, the relative orientation component of the observed row of rails with respect to the inertial unit is an orientation angle relative to a vertical longitudinal plane (V) of the vehicle, and the absolute orientation component of the inertial unit is a pitch angle, the integral I(l) being a longitudinal level parameter. If θ_{R} is the instantaneous value of the angle determined by the measuring equipment in the vertical longitudinal plane between the longitudinal direction of the inertial measurement unit and the direction of the observed row of rails, and θ_{C} the instantaneous value of the pitch angle determined simultaneously by the inertial unit, the absolute orientation component ψ_{A} of the row of rails can be expressed as the algebraic sum:

$${θ}_{A} = {θ}_{R} + {θ}_{C} \qquad [ Math 3 ]$$

Preferably, the operations of calculating successive values of at least one absolute orientation component of one of the two observed rows of rails, constructing the function s→G(s), applying a linear filter, constructing the filtered function s→F(s), and estimating the integral I(l) are carried out in parallel in order to obtain the intrinsic alignment coordinate and the intrinsic longitudinal level coordinate.

In one embodiment, the measuring equipment delivers at least two simultaneous signals for measuring the lateral distance between two reference points on the vehicle and the observed row of rails, the two reference points being at a distance (A) greater than 250 mm, and preferably greater than 500 mm, from each other. If A is the distance between the two reference points for the same observed row of rails, y₁ and y₂ are the lateral distances measured between the observed row of rails and each reference point and assuming that when y₁=y₂, the longitudinal axis of the inertial unit is aligned with the longitudinal axis of the row of rails, the measuring equipment provides access to the relative orientation component constituted by the yaw angle VR of the inertial unit in relation to the observed row of rails, using the equation:

$${ψ}_{R} = arc tan ( \frac{{y}_{1} - {y}_{2}}{A} ) \qquad [ Math 4 ]$$

In one embodiment, the measuring equipment delivers at least two simultaneous signals for measuring the vertical distance between two reference points on the vehicle and the observed row of rails, the two reference points being separated from each other by a distance (B) greater than 250 mm, and preferably greater than 500 mm. If B is the distance between the two reference points for the same observed row of rails, z₁ and z₂ are the vertical distances measured between the observed row of rails and each reference point and assuming that when z₁=z₂, the longitudinal axis of the inertial unit is aligned with the longitudinal axis of the row of rails, the measuring equipment provides access to the relative orientation component constituted by the yaw angle θ_{R} of the inertial unit in relation to the observed row of rails, using the equation:

$${θ}_{R} = arc tan ( \frac{{z}_{1} - {z}_{2}}{B} ) \qquad [ Math 5 ]$$

The measuring equipment's sensors can operate on different principles (optical, magnetic, capacitive, etc.), which operate linearly and optimally within a relatively narrow operating range. It is therefore beneficial to ensure that the vehicle's positioning on the track, both vertically and laterally, is close to an “ideal” alignment position at all times. For this purpose, at least one actuator for correcting the alignment of the vehicle on the track can be controlled as a function of the signals produced by the measuring equipment, or of successive values of the relative orientation component of the observed row of rails with respect to the inertial unit, in order to reduce a drift between the signals produced by the measuring equipment and predetermined values, or to reduce a drift between successive values of the relative orientation component of the observed row of rails and a predetermined value of the relative orientation component of the observed row of rails. The correction operation is particularly useful for a vehicle running on a single pair of wheels.

In one embodiment, the operation of determining the successive curved-abscissa values of the vehicle on the observed row of rails is performed as a function of at least the signals produced by an odometer associated with the observed row of rails from among the odometers. If each row of rails is associated with at least one odometer, this operation can be carried out for each row of rails.

In one embodiment, the operation of determining the successive curved-abscissa values of the vehicle on the observed row of rails is performed as a function of at least the signals produced by an odometer which is not associated with the observed row of rails from among the odometers and signals produced by the measuring equipment. If only one of the rows of rails is associated with an odometer, this operation can be performed for the other row.

In practice, the wheels to which the odometer(s) are connected may transiently lose contact with the observed row of rails, in which case the signals produced no longer provide reliable information on the vehicle's position relative to the observed row of rails. In one embodiment, failures of the odometer(s) are detected by comparing longitudinal acceleration values produced by the inertial unit with average acceleration values determined as a function of the signals produced by the odometer(s) and/or by comparing angular velocity values about a vertical axis produced by the inertial unit with angular velocity values deduced from the signals produced by the odometer(s). Preferably, when a failure is detected, a safety procedure is carried out, wherein successive curved-abscissa values of the vehicle on each of the two rows of rails are determined as a function of at least accelerometric or angular velocity signals produced by the inertial unit.

Another aspect of the invention relates to a system for implementing the method according to the first aspect of the invention, or one of its embodiments, comprising a vehicle capable of traveling on a railroad track with two parallel rows of rails, the vehicle carrying an inertial unit with at least three gyrometers and three accelerometers, a piece of equipment for measuring a relative orientation of each of the two rows of rails with respect to the inertial unit, and one or more odometers, characterized in that the system further comprises computing means programmed to perform the operations of computing successive values of at least one absolute orientation or positioning component of an observed row of rails from among the two rows of rails, constructing the function s→G(s), applying a linear filter, constructing the filtered function s→F(s), and estimating the integral I(l).

In one embodiment, the measuring equipment comprises, associated with each of the two rows of rails, at least two sensors for measuring the lateral distance between two reference points on the vehicle and the associated row of rails, the two reference points being separated from each other by a distance (A) greater than 250 mm, and preferably greater than 500 mm. Each sensor is dedicated to measuring a lateral distance at one of the reference points.

In one embodiment, the measuring equipment comprises, associated with each of the two rows of rails, at least two sensors for measuring the vertical distance between two reference points on the vehicle and the associated row of rails, the two reference points being separated from each other by a distance (B) greater than 250 mm, and preferably greater than 500 mm. Each sensor is dedicated to measuring a vertical distance at one of the reference points.

Other principles for measuring the relative orientation of the inertial unit with respect to each row of rails are also foreseeable. In one embodiment, the measuring equipment comprises at least one and preferably at least two cameras for detecting one or more linear laser beams projected onto each of the rows of rails. For example, each camera can capture the position of a laser line projected onto the observed row of rails, with the measuring equipment determining by triangulation the relative vertical and lateral position between the observed row of rails and the camera, placed in the reference frame of the inertial unit.

In another embodiment, the measuring equipment comprises at least one, and preferably at least two, laser rangefinders scanning the rows of rails of the track. Following the principle of laser telemetry, distance is given by measuring the delay between the emission of a pulse and the detection of a reflected pulse. The projected laser beam is directed by a rotating mirror, which scans a plane of space that can cover both rows of rails, and triangulates each row of rails to derive a lateral distance measurement and a vertical distance measurement. With two laser rangefinders placed at a distance from each other in the longitudinal direction of the vehicle, it is possible to obtain the eight dimensions required, i.e. four lateral distances and four vertical distances.

If required, the measuring equipment may further comprise a track gauge sensor, although this dimension can be deduced by measuring the lateral distance between the various reference points and the two rows of rails. If required, the measuring equipment may further comprise a track cant sensor.

In one embodiment, the vehicle is a two-wheeled cart, driven by a machine and connected to the machine via at least three links for controlling the attitude and alignment of the cart as a function of relative orientation components.

In an alternative embodiment, the vehicle is a cart with at least four wheels.

### BRIEF DESCRIPTION OF THE FIGURES

Other features and advantages of the invention will become apparent on reading the following description, with reference to the appended figures, which show:

FIG. 1, a schematic side view of a system for determining the geometry parameters of a railroad track according to one embodiment of the invention;

FIG. 2, a schematic top view of the system of FIG. 1;

FIG. 3, a schematic view of the distance sensors integrated into the measuring equipment of the system shown in FIG. 1;

FIG. 4, a schematic diagram of a method for determining the geometry parameters of a track according to one embodiment of the invention;

FIG. 5, a visualization diagram of a filtering operation in the method shown in FIG. 4.

For greater clarity, identical or similar elements are identified by identical reference signs in all of the Figures.

### DETAILED DESCRIPTION OF EMBODIMENTS

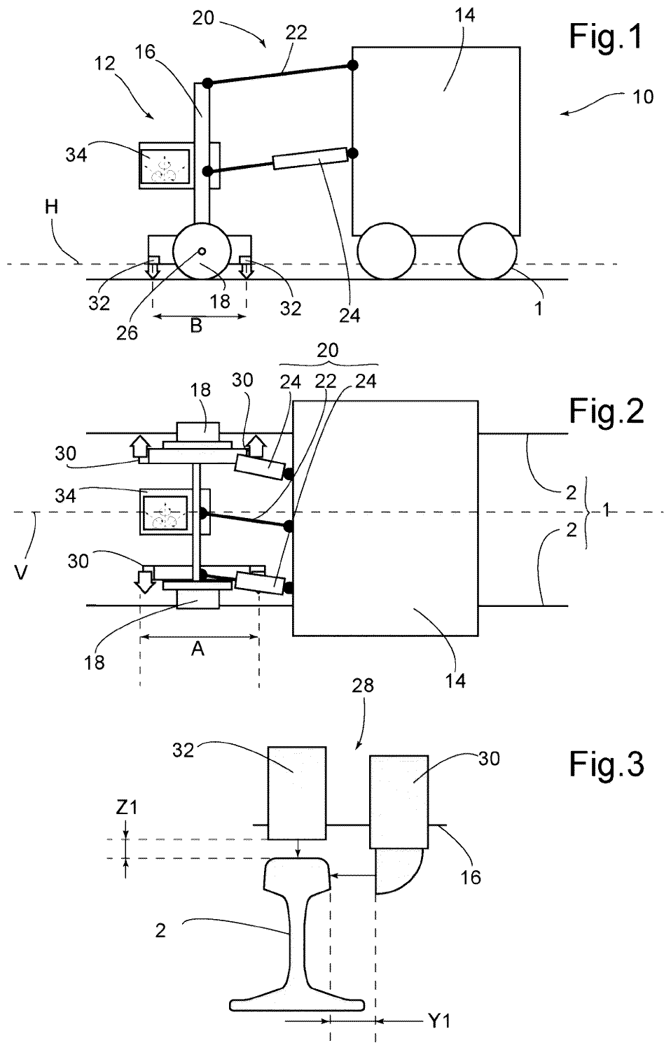

FIGS. 1 and 2 illustrate a system 10 for determining at least one geometry parameter of a track 1 with two rails 2, comprising a vehicle 12 able to travel on the track, coupled to a rail machine 14, which may in particular be a machine for laying, repairing, or replacing the track. The vehicle 12 is in this case a cart comprising a non-deformable chassis 16 resting on a single pair of wheels 18, possibly with a primary suspension in between. Preferably, the cart 12 has no means of propulsion, and is simply pulled or pushed by the rail machine 14 as it moves along the track. The coupling 20 linking the cart 12 to the rail machine 14 is here constituted by a connection with two ball joints 22 and two cylinders 24 to allow adjustment of the angular orientation of the chassis 16 with respect to the rail machine 14 and the track 1, particularly in a vertical plane and in a transverse plane. It should be noted, however, that the orientation of the chassis 16 relative to the track 1 may be adjusted by other adjustment means, in particular by controlling actuators arranged on a primary suspension between the chassis 16 and the wheels 18. Note also that the wheels 18 are preferably independent, in the sense that they rotate independently of each other.

The cart 12 is instrumented with various measuring devices, including at least one odometer 26 fitted to one of the wheels 18 of the cart 12, for example, to determine the distance traveled on the row of rails 2 on which the wheel 18 runs, or the curved-abscissa of the cart 12 relative to this row of rails 2. Preferably, each of the two wheels 18 is equipped with an odometer 26, so that the curved-abscissa of the cart 12 relative to each of the two rows of rails 2 of the track 1 can be determined directly.

The cart 12 further comprises measuring equipment 28 for determining the orientation of the chassis 16 relative to each row of rails 2, at least in one reference plane of the chassis 16, and preferably in at least two orthogonal planes, namely a horizontal plane H and a longitudinal vertical plane V.

To this end, the measuring equipment comprises, associated with at least one of the two rows of rails 2, and preferably with both of the two rows of rails 2, at least two sensors for measuring the lateral distance 30 between two reference points of the vehicle and the associated row of rails, the two reference points being separated from each other by a distance A, as shown in FIG. 2. If y₁ and y₂ are the measured lateral distances between the observed row of rails 2 and each reference point 30, and assuming that when y₁=y₂, the longitudinal axis of the chassis 16 is aligned with the longitudinal axis of the row of rails 2, the measuring equipment provides access to the relative orientation component constituted by the yaw angle ψ_{R} of the chassis relative to the row of rails observed in a horizontal plane, using the equation:

$${ψ}_{R} = arc tan ( \frac{{y}_{1} - {y}_{2}}{A} ) \qquad [ Math 6 ]$$

The accuracy of the result naturally increases with the distance A, which is preferably greater than 250 mm, and more preferably greater than 500.

In a similar way for the orientation of the cart chassis observed in a vertical plane V, the measuring equipment comprises, associated with at least one of the two rows of rails 2, and preferably with both of the two rows of rails 2, at least two sensors for measuring the vertical distance 32 between two reference points of the vehicle and the associated row of rails, as shown in FIG. 1. If B is the distance between the two reference points 32 for the same observed row of rails, which is preferably chosen to be greater than 250 mm, and more preferably greater than 500, and z₁ and z₂ are the vertical distances measured between the observed row of rails and each reference point and assuming that when z₁=z₂, the longitudinal axis of the chassis 16e is aligned with the longitudinal axis of the row of rails, the measuring equipment provides access to the relative orientation component constituted by the pitch angle θ_{R} of the chassis relative to the row of rails observed in a vertical longitudinal plane of the chassis, using the equation:

$${θ}_{R} = arc tan ( \frac{{z}_{1} - {z}_{2}}{B} ) \qquad [ Math 7 ]$$

The distance to the row of rails 2 can be measured using non-contact sensors 30, 32 as shown in FIG. 3, including proximity sensors, such as inductive, photoelectric, magnetic, capacitive or ultrasonic sensors. To avoid interference between sensors targeting the same region of a row of rails, two different types of sensors can be chosen for lateral and vertical distance measurements.

An inertial unit 34 with at least three gyrometers and three accelerometers is attached to the nondeformable chassis 16 of the cart 12.; this inertial unit 34 is referred to as a precision inertial unit, in the sense that it is able to deliver absolute orientation signals, i.e. without drift, in a geostationary reference frame. It is therefore a type of control unit whose gyroscopes are able to detect the projection of the earth's rotation and whose accelerometers are able to detect the projection of gravity.

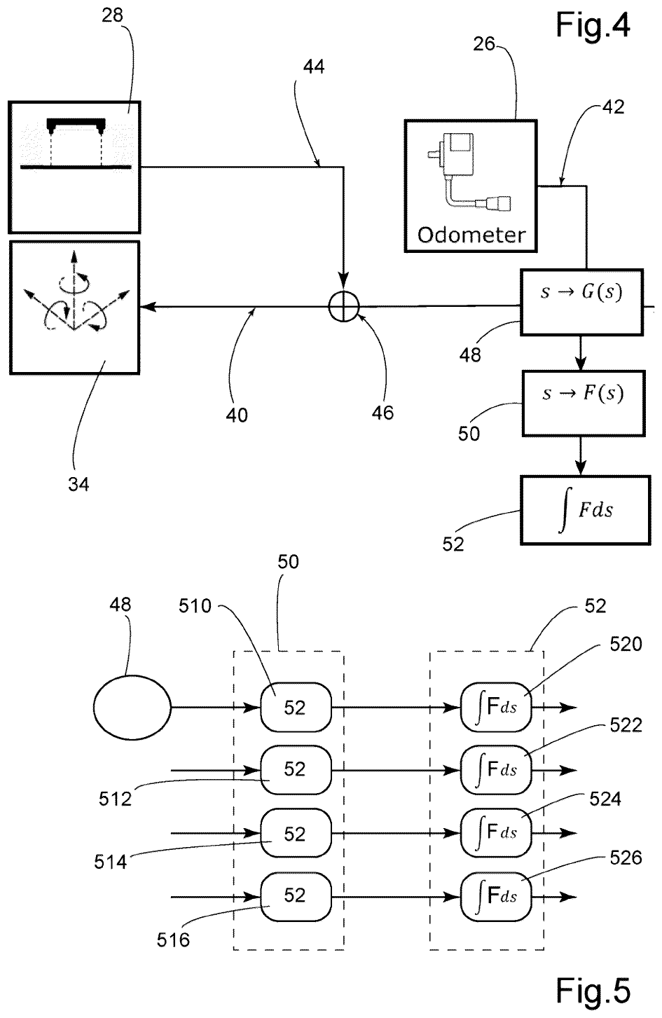

Instrumented in this way, the cart 12 can be used to determine the absolute orientation of the inertial unit 34 in a geostationary reference frame, and the relative orientation of each of the rows of rails 2 with respect to the chassis 16, and thus to the inertial unit 34 attached to the chassis 16. A specific procedure, shown in FIGS. 4 and 5, is proposed to deduce parameters of the geometry of each of the rows of rails 2 in an absolute reference frame from these metrological data.

As the cart 12 travels at low speed, in particular below 10 km/h, a speed which may not be constant, and as the machine 14 is likely to slow down or even stop for a prolonged period at the pace of the work being carried out on the track 1, the signals from the odometers 26, the measuring equipment 28 and the inertial unit 34 are sampled simultaneously at constant time intervals.

Successive values of at least one absolute orientation component of the inertial unit 34 in a geostationary reference frame, for example successive values of the roll angle and/or successive values of the pitch angle, are determined as a function of at least the signals produced by the inertial unit 34 (operation 40).

For at least one observed row of rails 2 of the two rows of rails, and preferably for each of the two rows of rails 2 taken as an observed row of rails, successive curved-abscissa values of the vehicle on the observed row of rails 2 are determined as a function of at least the signals produced by the odometer 26 associated with the observed row of rails (operation 42).

Based at least on signals produced by the measuring equipment 28, successive values are determined for at least one relative orientation component of the observed row of rails 2 with respect to the inertial unit 34, and preferably for both the components discussed above, i.e. the yaw angle ψ_{R} of the chassis relative to the observed row of rails 2, and the pitch angle θ_{R} of the chassis in relation to the observed row of rails (operation 44).

Based on these factors, it is possible to calculate, as a function of at least successive values of the absolute orientation component of the inertial unit and successive values of the relative orientation component of the observed row of rails with respect to the inertial unit, successive values of at least one absolute orientation or absolute positioning component of the observed row of rails 2. In practice, an algebraic sum of an instantaneous value of the absolute orientation component of the inertial unit and a simultaneous instantaneous value of the relative orientation component of each of the rows of rails observed with respect to the inertial unit is simply performed (operation 46).

Thus, if ψ_{R}(t) is the value, at a measuring instant t, of the angle determined by the measuring equipment 28 in the horizontal plane between the longitudinal direction of the inertial measurement unit 34 and the direction of the observed row of rails 2, and ψ_{C}(t) is the value at the same instant t of the yaw angle determined simultaneously by the inertial unit 34, the absolute orientation component ψ_{A}(t) of the observed row of rails can be expressed as the algebraic sum:

$${ψ}_{A} ( t ) = {ψ}_{R} ( t ) + {ψ}_{C} ( t ) \qquad [ Math 8 ]$$

Likewise, if θ_{R}(t) is the instantaneous value of the angle determined by the measuring equipment in the vertical longitudinal plane between the longitudinal direction of the inertial measurement unit 34 and the direction of the observed row of rails 2, and θ_{C}(t) the instantaneous value of the pitch angle determined simultaneously by the inertial unit 34, the absolute orientation component θ_{A}(t) of the row of rails can be expressed as the algebraic sum:

$${θ}_{A} ( t ) = {θ}_{R} ( t ) + {θ}_{C} ( t ) \qquad [ Math 9 ]$$

It is then possible to construct one or more functions s→G(s) linking at least some of the successive curved-abscissa values to concomitant values among the successive values of the absolute orientation or positioning component of the row of rails observed in space. (operation 48)

Thus, for the yaw component of one of the rows of rails, the function s→G_{L}(s) will be constructed by linking, for all or at least some of the measurement instants t, the value s(t) measured by the odometer associated with the observed row of rails to the value ψ_{A}(t). Similarly, the function s→G_{T}(s) will be constructed by linking, for all or at least some of the measurement instants t, the value s(t) measured by the odometer associated with the observed row of rails to the value θ_{A}(t).

Once this step has been completed in the time domain, one or more functions have been constructed s→G(s) where time no longer appears as a variable. It is then possible to apply a linear bandpass or high-pass filter, which is not a temporal filter but a spatial filter, to each function thus constructed, so as to construct a filtered function s→F(s) (operation 50). The linear filter used is preferably a finite impulse response filter of any order N, preferably greater than or equal to 2, which results in the following linear combination:

$$F ( {s}_{n} ) = {\sum }_{k = 0}^{N - 1} {b}_{k} \cdot G ( {s}_{n - k} ) \qquad [ Math 10 ]$$

where bₖ denotes the kth-order coefficient of the filter transfer function, and si denotes for 1≤i≤n the successive values of the curved-abscissa of the observed row of rails.

In practice, if the aim is to observe track geometry parameters in the wavelength ranges defined by the standard, at least one bandpass filter will be used in one of the three following bands: 3 m to 25 m (D1), 25 m to 70 m (D2), 70 m to 150 m (D3), or a bandpass filter implemented by a deflection calculation function (CF), and in practice, the operation 50 will be carried out in parallel for each of the desired wavelength ranges among those available, which is diagrammed in FIG. 5 by the parallel sub-operations 510, 512, 514, 516.

Finally, it is possible to estimate (operation 52), for a succession of current curved-abscissa values/among the curved-abscissa values, an integral I(l) is estimated over a given curved-abscissa interval bounded by a reference curved-abscissa value l₀ and by the current curved-abscissa value/, of the filtered function

$$I ( l ) = {\int }_{s = {l}_{o}}^{s = l} F ( s ) ds \qquad [ Math 11 ]$$

In practice, the integral I(l) is estimated by a Riemann sum or by the trapezoidal method over the given interval, with a step size of less than 25 cm, and preferably less than 1 cm. For example, with a Riemann sum:

$$I ( l ) \approx {\sum }_{n = 1}^{P} F ( {s}_{n} ) \cdot ( {s}_{n} - {s}_{n - 1} ) \qquad [ Math 12 ]$$

where s₀=l₀ and s_{P}=l are the bounds of the integration integral.

If required, this operation 52 is performed in parallel for each of the observed wavelength ranges, hence the parallel sub-operations 520, 522, 524, 526.

In the event that the relative orientation component of the observed row of rails 2 with respect to the inertial unit 34 is an orientation angle in a horizontal plane, and the absolute orientation component of the inertial unit is a yaw angle, the integral I(l) will be an alignment parameter.

In the event that the relative orientation component of the observed row of rails 2 with respect to the inertial unit 34 is an orientation angle relative to a vertical longitudinal plane of the vehicle, and the absolute orientation component of the inertial unit is a pitch angle, the integral I(l) will be a longitudinal level parameter.

In practice, calculations can be carried out in real time by a computer on-board the vehicle 12, on the machine 14, or located remotely.

In parallel with these calculation operations, signals produced by the measuring equipment 28 or successive values of the relative orientation component of the observed row of rails 2 with respect to the inertial unit 34 can be used to control the cylinders 24 for coupling the cart to the machine, with the aim of minimizing the misalignment between the chassis 16 of the cart 12 and the track 1.

When looking at the alignment with respect to the longitudinal direction in the horizontal plane, it is possible, for example, to construct a negative feedback loop aimed at minimizing the angle ψ_{R} observed for one of the rows of rails 2, or more simply, to minimize the absolute value of the difference |y₁−y₂| observed on one row of rails 2. When looking at both rows of rails, it is possible to construct a feedback loop aimed at minimizing the sum of the absolute values of the deviations observed for each of the two rows of rails:

$$( \vert {y}_{1} - {y}_{2} \vert + \vert {y}_{1} - {y}_{2} \vert ) .$$

Likewise, when looking at the alignment with respect to the longitudinal direction in the horizontal plane, it is possible, for example, to construct a negative feedback loop aimed at minimizing the angle θ_{R} observed for one of the rows of rails, or more simply, to minimize the absolute value of the difference |z₁−z₂| observed on one row of rails. When looking at both rows of rails, or aimed at minimizing the sum of the absolute values of the deviations observed for each of the two rows of rails: (|z₁−z₂|+|z₁−z₂|).

If necessary, failures of the odometer(s) 26 can be detected by comparing longitudinal acceleration values produced by the inertial unit 34 with average acceleration values determined as a function of the signals produced by the odometer(s) 26 and/or by comparing angular velocity values about a vertical axis produced by the inertial unit 34 with angular velocity values deduced from the signals produced by the odometer(s) 26. When a failure is detected, a degraded-mode operating procedure is carried out, wherein successive curved-abscissa values of the vehicle 12 on each of the two rows of rails 2 are determined as a function of at least accelerometric or angular velocity signals produced by the inertial unit 34.

Naturally, the examples shown in the figures and discussed above are provided for illustrative and non-limiting purposes only. It is explicitly provided that it is possible to combine the various illustrated embodiments in order to provide others.

As stated in the description of the invention, other principles for measuring the relative orientation of the inertial unit with respect to each row of rails are also foreseeable.

It is also possible to equip the cart with a single odometer, enabling direct measurement of the curved-abscissa of one of the rows of rails. The operation of determining the successive curved-abscissa values of the opposite row of rails can then be carried out as a function of at least the signals produced by the odometer and the signals produced by the measuring equipment.

The process of determining track geometry parameters described above can also be carried out using a four-wheeled cart, or more generally a rail vehicle that can rest on a plurality of wheelsets or bogies. If required, the chassis to which the inertial unit is attached can be linked to the wheels by one or more suspension stages, for example a primary suspension and/or a secondary suspension.

In these cases, the equipment used to measure the relative orientation of each row of rails with respect to the inertial measurement unit will preferably use measurement principles other than those described so far.

In one embodiment, the measuring equipment comprises at least one and preferably at least two cameras for detecting one or more linear laser beams projected onto each of the rows of rails. For example, each camera is fixed to the chassis carrying the inertial unit in a fixed manner in the reference frame of the inertial unit, and oriented so as to aim and capture the position of a laser line projected onto the observed row of rails, the measuring equipment determining by triangulation the relative vertical and lateral position between the observed row of rails and the camera.

In another embodiment, the measuring equipment comprises at least one, and preferably at least two, laser rangefinders, also positioned in the reference frame of the inertial unit, so as to scan the rows of rails of the track. Following the principle of laser telemetry, distance is given by measuring the delay between the emission of a pulse and the detection of a reflected pulse. The projected laser beam is directed by a rotating mirror, which scans a plane of space that can cover both rows of rails, and triangulates each row of rails to derive a lateral distance measurement and a vertical distance measurement. With two laser rangefinders placed at a distance from each other in the longitudinal direction of the vehicle, it is possible to obtain the eight dimensions required, i.e. four lateral distances and four vertical distances.

In another variant, the measuring equipment comprises at least one time-of-flight (ToF) camera placed in the inertial unit's reference frame, enabling a three-dimensional scene to be viewed in its field of vision. As the field of view of this type of camera is relatively narrow, it is advantageous to use one camera of this type per row of rails.

1. A method for determining at least one geometry parameter of a railroad track with two rows of rails, wherein:
a vehicle carrying an inertial unit, a piece of equipment for measuring at least one relative orientation component of at least one of the two rows of rails with respect to the inertial unit, and one or more odometers is made to travel over the track, the method comprising:
determining successive values of at least one absolute orientation component of the inertial unit in a geostationary reference frame as a function of at least signals produced by the inertial unit,
wherein for at least one observed row of rails out of the two rows of rails, or for each of the two rows of rails (2) taken as an observed row of rails,
i) successive values of curved-abscissa values of the vehicle on the observed row of rails are determined as a function of at least the signals produced by the odometer(s),
ii) successive values of at least one relative orientation component of the observed row of rails with respect to the inertial unit are determined as a function of at least the signals produced by the measuring equipment,
iii) successive values of at least one absolute orientation or absolute positioning component of the observed row of rails are calculated as a function of at least successive values of the absolute orientation component of the inertial unit and successive values of the relative orientation component of the observed row of rails with respect to the inertial unit,
wherein
a function s→G(s) is constructed which links at least some of the successive curved-abscissa values to concomitant values among the successive values of the absolute orientation or absolute positioning component of the row of rails observed in space,
wherein a high-pass or bandpass linear filter is applied to the function s→G(s) so as to construct a filtered function s→F(s), and
wherein for a succession of current curved-abscissa values l among the curved-abscissa values, an integral I(l) is estimated over a given curved-abscissa interval bounded by a reference curved-abscissa value l₀ and by the current curved-abscissa value l, of filtered function
$$I ( l ) = {\int }_{s = {l}_{o}}^{s = l} F ( s ) ds$$

2. The method of claim 1, wherein the linear filter is a bandpass filter or an arrow calculation function.

3. The method of claim 1, wherein the integral I (l) is estimated by a Riemann sum or by a trapezoidal method over the given interval, with a step size of less than 25 cm.

4. The method of claim 1, wherein calculating successive values of at least one absolute orientation or positioning component of the observed row of rails consists, at successive instants, of an algebraic sum of an instantaneous value of the absolute orientation component of the inertial unit and of a simultaneous instantaneous value of the relative orientation component of each of the observed rows of rails with respect to the inertial unit.

5. The method of claim 1, wherein the relative orientation component of the observed row of rails with respect to the inertial unit is an orientation angle in a horizontal plane, and the absolute orientation component of the inertial unit is a yaw angle, the integral I(l) being an alignment parameter.

6. The method of claim 1, wherein the relative orientation component of the observed row of rails with respect to the inertial unit is an orientation angle in a vertical plane (V) of the vehicle, and the absolute orientation component of the inertial unit is a pitch angle, the integral I(l) being a longitudinal level parameter.

7. The method of claim 1, wherein for each observed row of rails, the measuring equipment produces at least two simultaneous signals for measuring a lateral distance between two reference points on the vehicle and the observed row of rails, the two reference points being separated from one other by a distance (A) greater than 250 mm.

8. The method of claim 1, wherein for each observed row of rails, the measuring equipment produces at least two simultaneous signals for measuring a vertical distance between two reference points of the vehicle and the observed row of rails, the two reference points being separated from one other by a distance (B) greater than 250 mm.

9. The method of claim 1, wherein at least one actuator for correcting alignment of the vehicle on the track is controlled as a function of the signals produced by the measuring equipment, or of successive values of the relative orientation component of the observed row of rails with respect to the inertial unit, such as to reduce a drift between the signals produced by the measuring equipment and predetermined values, or to reduce a drift between successive values of the relative orientation component of the observed row of rails and a predetermined value of the relative orientation component of the observed row of rails.

10. The method of claim 1, wherein determining the successive curved-abscissa values of the vehicle on the observed row of rails is performed as a function of at least the signals produced by an odometer associated with the observed row of rails from among the odometers.

11. The method of claim 1, wherein determining the successive curved-abscissa values of the vehicle on the observed row of rails is performed as a function of at least the signals produced by an odometer which is not associated with the observed row of rails from among the odometers and signals produced by the measuring equipment.

12. The method of claim 1, wherein failures of the odometer(s) are detected by comparing longitudinal acceleration values produced by the inertial unit with average acceleration values determined as a function of the signals produced by the odometer(s) and/or by comparing angular velocity values about a vertical axis produced by the inertial unit with angular velocity values deduced from the signals produced by the odometer(s).

13. The method of claim 12, wherein when a failure is detected, a safety procedure is carried out, wherein successive curved-abscissa values of the vehicle on each of the two rows of rails are determined as a function of at least accelerometric or angular velocity signals produced by the inertial unit.

14. A system for implementing the method of claim 1, the system comprising:
a vehicle capable of traveling on a railroad track with two parallel rows of rails, the vehicle carrying an inertial unit with at least three gyrometers and three accelerometers;
a piece of equipment for measuring a relative orientation of each of the two rows of rails with respect to the inertial unit, and one or more odometers; and
computing means programmed to perform calculating successive values of at least one absolute orientation or positioning component of an observed row of rails from among the two rows of rails, constructing the function s→G(s), applying a linear filter, constructing the filtered function s→F(s), and estimating the integral I(l).

15. The system of claim 14, wherein the measuring equipment comprises, associated with each of the two rows of rails, at least two sensors for measuring a lateral distance between two reference points on the vehicle and associated row of rails, the two reference points being separated from each other by a distance (A) greater than 250 mm.

16. The system of claim 14, wherein the measuring equipment comprises, associated with each of the two rows of rails, at least two sensors for measuring a vertical distance between two reference points on the vehicle and the associated row of rails, the two reference points being separated from each other by a distance (B) greater than 250 mm.

17. The system of claim 14, wherein the measuring equipment comprises one or more cameras for detecting one or more linear laser beams projected onto each of the rows of rails.

18. The system of claim 14, wherein the measuring equipment comprises one or more two laser rangefinders scanning the rows of rails of the track.

19. The system of claim 14, wherein the vehicle is a two-wheeled cart, driven by a machine and connected to the machine via at least three links for controlling an attitude and an alignment of the cart as a function of relative orientation components.

20. The system of claim 14, wherein the vehicle is a cart with at least four wheels.
